(19) United States
(12) Patent Application Publication
(10) Pub. No.: US 2015/0304427 A1
(43) Pub. Date: Oct. 22, 2015

(54) EFFICIENT INTERNET PROTOCOL SECURITY AND NETWORK ADDRESS TRANSLATION

(71) Applicant: Alcatel-Lucent Canada, Inc., Ottawa (CA)

(72) Inventors: Erel Ortacdag, Ottawa (CA); Nirmesh Patel, Kanata (CA)

(73) Assignee: Alcatel-Lucent Canada, Inc., Ottawa (CA)

(21) Appl. No.: 14/258,444

(22) Filed: Apr. 22, 2014

(51) Int. Cl. H04L 29/08; H04L 29/06; H04L 29/12

(52) U.S. Cl. CPC H04L 67/14; H04L 61/2592; H04L 63/029

(57) ABSTRACT

Various exemplary embodiments relate to a method performed by a network processing device for creating a NAT session with a tunnel between two nodes, the method comprising: receiving a packet; determining the packet does not have a Security Association; establishing a Security Association associated with a tunnel; generating a tunnel identifier for the tunnel; creating a NAT session information; and storing the NAT session information and the tunnel identifier.

### TECHNICAL FIELD

Various exemplary embodiments disclosed herein relate generally to Network Address Translation and security at the IP layer of the Internet.

### BACKGROUND

Internet Protocol Security (IPsec) (IETF RFC4301) is a collection of protocols layered on top of standard Internet Protocol (IP) implementations for securing communications by authenticating and encrypting each IP packet of a communication session. IpSec provides layers of security to network traffic by providing protocols for end-to-end security for packets traversing a network, protecting data flows between a pair of hosts (host-to-host), between a pair of security gateways (network-to-network), or between a security gateway and a host (network-to-host). Methods include establishing mutual authentication between agents at the beginning of the session and negotiation of cryptographic keys to be used during the session.

Network Address Translation (NAT) (IETF RFC 2663) is a methodology most often used to map multiple private hosts to one publicly exposed IP address by modifying network address information in Internet Protocol (IP) datagram packet headers while they are in transit across a traffic routing device. In the reverse communications path, responses are mapped back to the originating IP addresses using the rules or “state” stored in translation tables on or connected to the routing device. As an example, NAT translates all network addresses assigned to devices behind a network node to a single IP address, where all IP packet headers are translated into the single IP address, usually with individual port numbers assigned to outbound traffic from each device, added to the packet headers as part of the translation process, and tracked by the node in a translation table. Return traffic with the port number assigned to each device will be directed to that device, respectively. The translation table rules established in this fashion are flushed after a short period unless new traffic refreshes their state.

IpSec and NAT can be deployed together to provide secure tunneling using a single public interface IP address to the public network. IPsec can be implemented in a host-to-host transport mode, as well as in a network tunnel mode. IpSec NAT-Traversal (RFC 3715 and 3947) tunnel mode is required to make IpSec tunnels work over a NAT router. IPsec virtual private network (VPN) clients may use NAT traversal so that Encapsulating Security Payload packets traverse NAT. IPsec uses several protocols which must be enabled to traverse firewalls and network address translators, including: 1) Internet Key Exchange (IKE)—User Datagram Protocol (UDP) port 500, 2) Encapsulating Security Payload (ESP)—IP protocol number 50, 3) Authentication Header (AH)—IP protocol number 51, and 4) IPsec NAT traversal—UDP port 4500 (when NAT traversal is in use). Many routers provide explicit features, often called IPsec Passthrough.

In IpSec NAT-Traversal mode, when a NAT session is created for an IpSec tunnel, the NAT process replaces the IP source address (SA) and source User Datagram Protocol (UDP) port of the IpSec IP header in the outbound direction (private to public). When an encrypted packet is received from the public far end (inbound direction), the NAT process uses a hash algorithm (based on IP destination address (DA), IP SA, IP Protocol, UDP destination and source port numbers) to find the NAT session and then the Network Processor (NP), Field Programmable Gate Array (FPGA), or Application Specific Integrated Circuits (ASIC) replaces the IP DA and destination port of the IpSec header with the original IpSec tunnel IP address and UDP port numbers. Typically, then a second longest prefix match (LPM) route lookup is required to find where the IpSec packet should be routed; where the destination may be on the same router, such that the incoming packet may need to be decrypted, or routed to another port, in which case the incoming packet is routed without decryption. Each time routing lookup is performed, service performance is impacted—LPM lookups are usually resource-expensive due to either instructions/memory bandwidth, or due to latency when Content Addressable Memory (CAM) is used, as is common, instead of a single straight memory lookup. For example, routing lookups consume memory bandwidth and processing cycles if implemented in a network processor, which will slow other processes on the NP, or if, to reduce the strain on the NP, routing lookups are performed in external devices such as a ternary CAM (TCAM), packet processing cycles and latency will increase, impacting overall single-flow performance.

### SUMMARY

In light of the present need for more efficient IpSec NAT-Traversal, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a network processing device for creating a NAT session with a tunnel between two nodes, the method including receiving a packet, determining the packet does not have a Security Association, establishing a Security Association associated with a tunnel, generating a tunnel identifier for the tunnel, creating a NAT session information, and storing the NAT session information and the tunnel identifier. In some embodiments of the invention, the step of creating a NAT session information further includes performing a hash on a destination address, a source address, a protocol, and a port information stored in header fields of the packet. In another embodiment of the invention, the step of establishing a Security Association further includes sending a request to a remote node, where the request comprises a cryptographic key, information identifying a first network endpoint and a first port and a second network endpoint and a second ports, and a tunnel type. In alternative embodiments of the invention, the second network endpoint is determined by information stored in header fields of the packet. In some embodiments of the invention, the method includes generating a NAT session request comprising the tunnel identifier.

Various exemplary embodiments relate to a method performed by a network processing device for processing a packet, including receiving an encrypted packet comprising an encrypted first set of headers and an unencrypted second set of headers, determining a NAT session information from the unencrypted first set of headers, determining the NAT session information is associated with a tunnel, decrypting the packet, and sending the packet towards a destination address stored in the first set of headers. In some embodiments, the step of determining the NAT session information further includes performing a hash on a destination address, a source address, a protocol, and a port information stored in the second set of headers, and locating the NAT session information that matches the hash, where the NAT session information is stored in a table and comprises the hash. In other embodiments, the step of determining the NAT session information is associated with a tunnel further includes determining the NAT session information comprises a tunnel identifier. In some embodiments, the step of sending the packet towards a destination address stored in the first set of headers includes performing a route lookup on the header information in the decrypted packet. In other embodiments, the method includes determining the NAT session information is associated with an expired NAT session, creating a new NAT session information, and storing the new NAT session information and a tunnel identifier associated with the tunnel.

Various exemplary embodiments relate to a non-transitory machine-readable storage medium encoded with instructions for execution by a network processing device for creating a NAT session with a tunnel between two nodes, the non-transitory machine-readable storage medium including instructions for receiving, at the network processing device, a packet; instructions for determining the packet does not have a Security Association; instructions for establishing a Security Association associated with a tunnel; instructions for generating a tunnel identifier for the tunnel; instructions for creating a NAT session information; and instructions for storing the NAT session information and the tunnel identifier in a data store. In other embodiments, the instructions for creating a NAT session information include instructions for performing a hash on a destination address, a source address, a protocol, and a port information stored in header fields of the packet.

In some embodiments, the instructions for establishing a Security Association further include instructions for sending a request to a remote node, wherein the request comprises a cryptographic key, information identifying a first network endpoint and a first port and a second network endpoint and a second ports, and a tunnel type. Alternative embodiments include instructions for determining the second network endpoint based upon information stored in header fields of the packet. Some embodiments include instructions for generating a NAT session request comprising the tunnel identifier.

Various exemplary embodiments relate to a non-transitory machine-readable storage medium encoded with instructions for execution by a network processing device for processing a packet, the non-transitory machine-readable storage medium including instructions for receiving, at the network processing device, an encrypted packet comprising an encrypted first set of headers and an unencrypted second set of headers; instructions for determining a NAT session information from the unencrypted first set of headers; instructions for determining the NAT session information is associated with a tunnel; instructions for decrypting the packet; and instructions for sending the packet towards a destination address stored in the first set of headers. In alternative embodiments, the instructions for determining the NAT session information include instructions for performing a hash on a destination address, a source address, a protocol, and a port information stored in the second set of headers; and instructions for locating the NAT session information that matches the hash, wherein the NAT session information is stored in a table and comprises the hash. In some embodiments, the instructions for determining the NAT session information is associated with a tunnel include instructions for determining the NAT session information comprises a tunnel identifier. In other embodiments, the instructions for sending the packet towards a destination address stored in the first set of headers also include instructions for performing a route lookup on the header information in the decrypted packet. In other embodiments, the non-transitory machine-readable storage medium also includes instructions for determining the NAT session information is associated with an expired NAT session, instructions for creating a new NAT session information, and instructions for storing the new NAT session information and a tunnel identifier associated with the tunnel.

It should be apparent that, in this manner, various exemplary embodiments enable efficient IpSec NAT-Traversal. In particular, by avoiding additional lookups in the inbound direction.

### BRIEF DESCRIPTION OF THE DRAWINGS

In order to better understand various exemplary embodiments, reference is made to the accompanying drawings, wherein:

FIG. 1 illustrates an exemplary process of the creation of a NAT session with IpSec tunnel;

FIG. 2 illustrates an exemplary method for processing by a network processor second and successive outbound clear text packets;

FIG. 3 illustrates an exemplary method of processing the inbound flow of IpSec packets;

FIG. 4 illustrates an exemplary efficient method of handling inbound IpSec packets;

FIG. 5 illustrates an exemplary hardware diagram 500 for implementing a network node for handling inbound IpSec packets.

To facilitate understanding, identical reference numerals have been used to designate elements having substantially the same or similar structure or substantially the same or similar function.

### DETAILED DESCRIPTION

In view of the foregoing, it would be desirable to avoid additional lookups in the inbound direction to the extent possible in order to free up precious resources in network devices.

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

Because routing lookups are resource-expensive and their use introduces performance delays, it is preferable to avoid a second round of lookups in the inbound direction when IpSec and NAT are combined in IpSec tunnel mode.

Referring now to the drawings, in which like numerals refer to like components or steps, there are disclosed broad aspects of various exemplary embodiments.

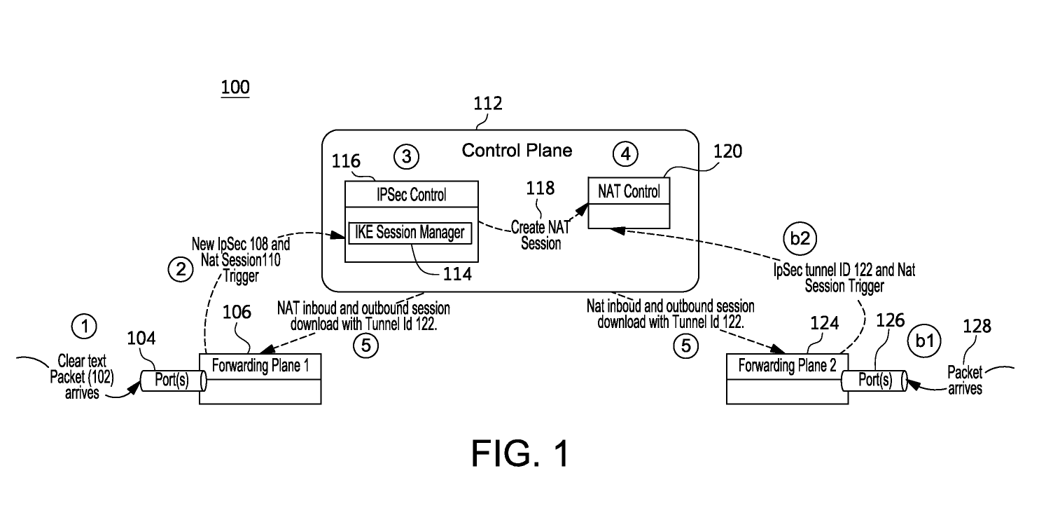

FIG. 1 illustrates an exemplary process 100 of the creation of a NAT session with an IpSec tunnel between two nodes. In a first step (1), a clear text packet 102 arrives to a port 104 on a first forwarding plane 106. As shown in FIG. 1, the process may apply to multiple forwarding planes, e.g. forwarding planes 106 and 124, but for purposes of illustration the detailed description will follow the clear text packet 102 arriving at a port 104 of forwarding plane 106. One of skill in the art will appreciate that the steps described with respect to first forwarding plane 106 will also apply to similar marked steps in second forwarding plane 124, and any additional forwarding planes similarly configured (not shown).

In the next step (2), where this is the first packet for the IpSec tunnel, the forwarding plane 106 will not have an IpSec Security Association (SA), and hence no associated NAT session to forward the packet through a tunnel to a remote node. To establish the NAT session 110 the forwarding plane 106 notifies the control plane 112 to trigger a new IpSec SA and NAT session 110. In a next step (3) in the control plane 112, an IKE session manager 114 in the IpSec Control stack 116 negotiates an IpSec Security Association (for example, the association may include an advanced encryption system (AES) key (but other encryption methods may be used), information identifying the IP endpoints and ports that are to be protected, as well as what type of IPsec tunnel has been created) with the node at the end of the tunnel (the end node is designated by the headers of clear text packet 102) and triggers a NAT session request 118 containing the resulting IpSec tunnel identifier 122. In other words, the IpSec Control stack will generate a tunnel ID 122 and pass it to the NAT Control stack 120 as an element of a NAT session request 118.

In the next step (4) of process 100, the NAT control stack 120 creates a NAT session 110 based on the result of a hash of the IP DA, the IP SA, IP Protocol, UDP destination and UDP source port numbers, and stores the IpSec tunnel identifier 122 and NAT session information. One of skill in the art will appreciate that the NAT control 120 will modify the source address and port numbers of outbound packet 102 to convert them to the address of the node hosting forwarding planes 1 and 2, and a port indicating the NAT and/or IpSec control, but will not convert the destination address and port numbers of outbound packet 102. In the next step (5) the NAT control stack 120 uploads the inbound and outbound NAT session information including the converted IP SA and UDP source port, and tunnel identifier 122 to all the forwarding planes 106, 124 such that the IP Sec tunnel that originally triggered the creation of the NAT session may be co-identified with the NAT session information as an entry in translation tables stored at the forwarding planes 106, 124.

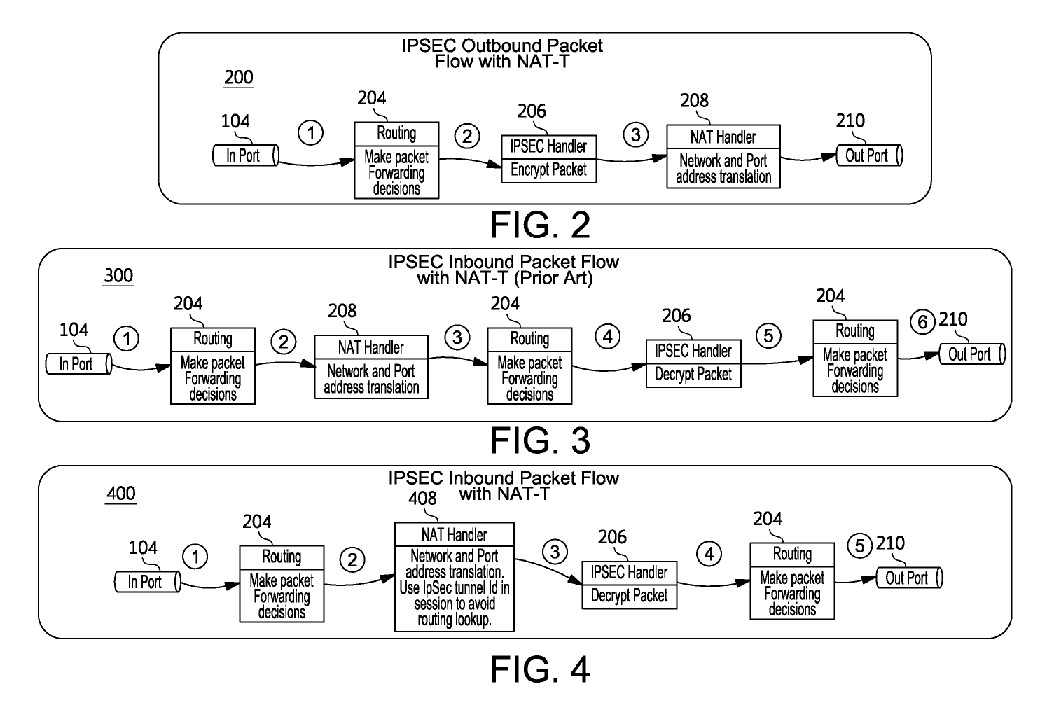

FIG. 2 illustrates an exemplary method 200 for processing the second and successive clear text packets in the outbound direction by the NP. In a first step (1) a clear text packet is received at port 104 and IP routing lookup is performed 204 based on the headers of the clear text packet. If it is determined 204 that the destination should be the IpSec handler 206 in IpSec Control 116, in the next step (2) the IpSec handler 206 encrypts the packet including the original headers, and adds IpSec headers. If the IpSec tunnel is NATed, the IpSec handler 206 forwards the packet to the NAT handler 208. At this step (3), the NAT handler 208 changes the IP SA and UDP source port number in the IpSec header to the NAT session values from a translation table and transmits the encrypted and NATed packet towards the far end of the tunnel via port 210. In other words, in the combination of IpSec and NAT, during NAT, the end result of translation is that in the unencrypted portion of the packet the tunnel header becomes the IP header and the UDP header assigned by NAT and includes the port negotiated by the IKE Session Manager 114 with a remote node, which may be associated at the forwarding plane with the tunnel ID 122 created during process 100. The payload of the packet, including the original headers, is encrypted. Note that in the embodiments shown by process 100 and process 200, the tunnel identifier 122 is maintained at forwarding planes 106 and 124, and manipulated by Control plane 112, but is not transmitted to a remote node. A person of skill in the art will appreciate that alternative embodiments may transmit to the remote node one or more local identifiers for the tunnel denoted by tunnel identifier 122.

For purposes of illustration, FIG. 3 illustrates an exemplary prior art method 300 of handling inbound IpSec packets. In a first step (1), an encrypted packet is received through port 104 by the forwarding plane 106 and IP routing lookup is performed 204 on the unencrypted NATed headers of the encrypted packet. In a second step (2), the packet is sent to NAT handler 208 which performs a hash of the IP DA, IP SA, IP Protocol and UDP destination and UDP source port numbers, finds the NAT session that matches the resulting hash, and replaces the IP DA and the UDP destination port number with the original IP address and the port number previously assigned in the translation table when the NAT session was created (or the table was last updated). In a third step (3), the NAT handler 208 sends the packet back to Routing handler 204 to do an IP route lookup on the IP address replaced by the NAT handler 208, which will indicate the IpSec handler 206 as the destination. Once the packet is routed to the IpSec handler, in the next step (4) the packet is decrypted and again sent to the Routing handler 204. In step (5), Routing handler 204 performs an IP route lookup on the header information in the decrypted packet to send the packet to its final destination, and the clear text packet is finally (6) transmitted out from port 210.

FIG. 4 illustrates an exemplary efficient method of handling inbound IpSec packets. In a first step (1), an encrypted packet is received through port 104 by the forwarding plane 106 and IP routing lookup is performed 204 on the unencrypted NATed headers. In a second step (2), the packet is sent to NAT handler 408, which performs a hash on the IP DA, IP SA, IP Protocol and UDP destination and UDP source port numbers, and finds the NAT session that matches the resulting hash. One of skill in the art will appreciate that the IP DA and UDP destination port of a NATed incoming packet will be equivalent to the IP SA and UDP source address as modified by the NAT control 120 and forwarded to the forwarding planes 106 and 124 in step (5) of process 100.

The NAT handler 408 checks if any IpSec tunnel is configured on the matching NAT session. If the NAT handler 408 finds that an IpSec tunnel identifier 122 was configured by the Control plane 112 in process 100 and associated with the NAT session information, the packet is sent directly to IpSec handler 206. In the next step (3), IpSec handler 206 decrypts the packet and sends the decrypted IP packet to the Routing handler 204. In step (4), the Routing handler 204 performs an IP route lookup on the header information in the decrypted packet to send the packet to its final destination, and the clear text packet is (5) transmitted out from port 210.

With reference to FIG. 1, in an additional exemplary embodiment, it is possible that a timer associated with a NAT session may be smaller than a timer associated with an IpSec session associated with the NAT session, such that the NAT session will expire before the IpSec session, but the IP tunnel 122 will still be recognized by control plane 112. In this case, an IP lookup triggered by an incoming IP packet 128 at a port 126 of forwarding plane 124 associated with the expired NAT session will attempt to lookup a non-existent NAT session. In this instance, in step (b1) the first incoming packet after the NAT session expires will be handled according to prior art method 300, where the incoming packet will be routed in step (3) of method 300 according to the destination address and UDP destination port in the unencrypted headers of the incoming packet 128. However, the incoming packet 128 will trigger the creation in step (b2) of a new NAT session, following steps (4)-(5) of process 100, and, assuming the creation of the new NAT session is successful such that the NAT handler 208 allocates the same source port and IP address allocation as the original session, subsequent incoming packets will be handled according to process 400 as discussed above. If for some reason the same source port and IP address allocation is unavailable and the NAT handler 208 allocates a new and different address or source port, the session will eventually terminate because the receiving device will discard packets received with an address or source port different from the original.

In some further alternative embodiments, if the NAT session has expired but a tunnel identifier 122 can still be determined at the forwarding plane, in step (b2) the tunnel identifier will be sent from the forwarding plane 124 to the control plane 112 to be passed with a NAT session request to the NAT control 120. In other embodiments, if the tunnel identifier 122 cannot be determined at the control plane 124, a tunnel identifier stored at Control plane 112 may be passed with a NAT session request to the NAT control 120. Note that in this scenario, IpSec control would not be involved, since the IpSec session would still be active and therefore re-negotiation with the remote node would not be required; the control plane would create the new NAT session independently of IpSec Control and associate the NAT session information either with stored IpSec tunnel ID information or an IpSec tunnel identifier 122 passed from the forwarding plane 124.

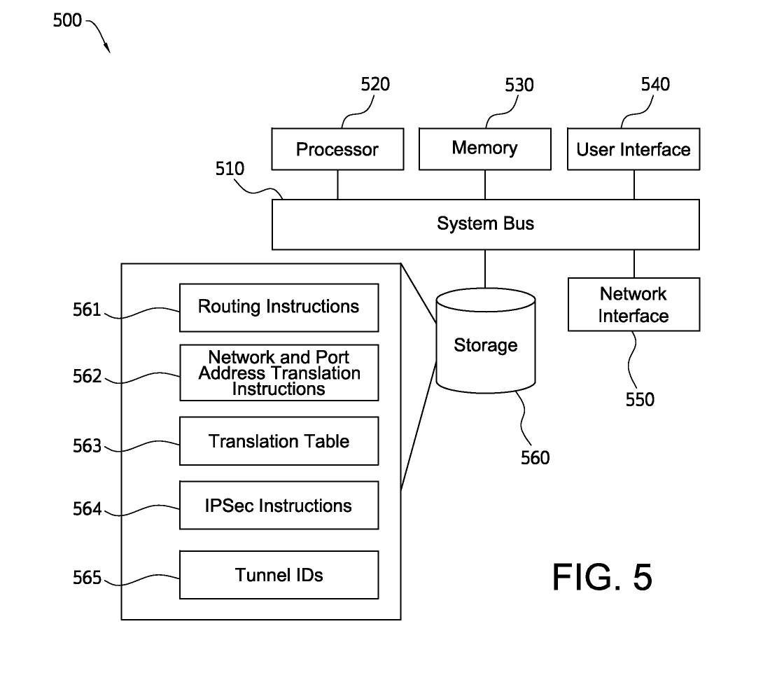

FIG. 5 illustrates an exemplary hardware diagram 500 for implementing a routing device, network node, or Network Processor. The exemplary hardware 500 may correspond to any of the devices, forwarding planes, or control planes shown in processes 100, 200, 300, or 400. As shown, the hardware 500 includes a processor 520, memory 530, user interface 540, network interface 550, and storage 560 interconnected via one or more system buses 510. It will be understood that FIG. 5 constitutes, in some respects, an abstraction and that the actual organization of the components of the hardware 500 may be more complex than illustrated.

The processor 520 may be any hardware device capable of executing instructions stored in memory 530 or storage 560. As such, the processor may include a microprocessor, field programmable gate array (FPGA), application-specific integrated circuit (ASIC), or other similar devices.

The memory 530 may include various memories such as, for example L1, L2, or L3 cache or system memory. As such, the memory 530 may include static random access memory (SRAM), dynamic RAM (DRAM), flash memory, read only memory (ROM), or other similar memory devices.

The user interface 540 may include one or more devices for enabling communication with a user such as an administrator. For example, the user interface 540 may include a display, a mouse, and a keyboard for receiving user commands.

The network interface 550 may include one or more devices for enabling communication with other hardware devices. For example, the network interface 550 may include a network interface card (NIC) configured to communicate according to the Ethernet protocol. Additionally, the network interface 550 may implement a TCP/IP stack for communication according to the TCP/IP protocols. Various alternative or additional hardware or configurations for the network interface 550 will be apparent.

The storage 560 may include one or more machine-readable storage media such as read-only memory (ROM), random-access memory (RAM), magnetic disk storage media, optical storage media, flash-memory devices, or similar storage media. In various embodiments, the storage 560 may store instructions for execution by the processor 520 or data upon which the processor 520 may operate. For example, the storage 560 may store routing instructions 561 for coordinating basic network processor functionality such as receiving packets, determining a next hop, forwarding packets, and reporting events. The storage may store NAT instructions 562 for translating IP packet addresses and port numbers and store the matching addresses in one or more translation tables 563. The storage 560 may also store IpSec instructions for negotiating secure network tunnels which are tracked and stored as Tunnel IDs 565.

It will be apparent that various information described as stored in the storage 560 may be additionally or alternatively stored in the memory 530. In this respect, the memory 530 may also be considered to constitute a “storage device.” Various other arrangements will be apparent. Further, the memory 530 and storage 560 may both be considered to be “non-transitory machine-readable media.” As used herein, the term “non-transitory” will be understood to exclude transitory signals but to include all forms of storage, including both volatile and non-volatile memories.

While the hardware 500 is shown as including one of each described component, the various components may be duplicated in various embodiments. For example, the processor 520 may include multiple microprocessors that are configured to independently execute the methods described herein or are configured to perform steps or subroutines of the methods described herein such that the multiple processors cooperate to achieve the functionality described herein. Various other arrangements will be apparent.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

1. A method performed by a network processing device for creating a NAT session with a tunnel between two nodes, the method comprising:
receiving a packet;
determining the packet does not have a Security Association;
establishing a Security Association associated with a tunnel;
generating a tunnel identifier for the tunnel, wherein the tunnel identifier is to be used in a NAT session request;
creating a NAT session information; and
storing the NAT session information and the tunnel identifier.

2. The method of claim 1, where the step of creating a NAT session information further comprises:
performing a hash on a destination address, a source address, a protocol, and a port information stored in header fields of the packet.

3. The method of claim 1, wherein the step of establishing a Security Association further comprises:
sending a request to a remote node, wherein the request comprises a cryptographic key, information identifying a first network endpoint and a first port and a second network endpoint and a second port, and a tunnel type.

4. The method of claim 3, wherein the second network endpoint is determined by information stored in header fields of the packet.

5. The method of claim 1, further comprising:
generating a NAT session request comprising the tunnel identifier.

6. A method performed by a network processing device for processing a packet, the method comprising:
receiving an encrypted packet comprising an encrypted first set of headers and an unencrypted second set of headers;
determining a NAT session information from the unencrypted first set of headers;
determining the NAT session information is associated with a tunnel;
decrypting the packet; and
sending the packet towards a destination address stored in the first set of headers.

7. The method of claim 6, wherein the step of determining the NAT session information further comprises:
performing a hash on a destination address, a source address, a protocol, and a port information stored in the second set of headers; and
locating the NAT session information that matches the hash, where the NAT session information is stored in a table and comprises the hash.

8. The method of claim 6, wherein the step of determining the NAT session information is associated with a tunnel further comprises:
determining the NAT session information comprises a tunnel identifier.

9. The method of claim 6, wherein the step of sending the packet towards a destination address stored in the first set of headers further comprises:
performing a route lookup on the header information in the decrypted packet.

10. The method of claim 6 further comprising:
determining the NAT session information is associated with an expired NAT session;
creating a new NAT session information; and
storing the new NAT session information and a tunnel identifier associated with the tunnel.

11. A non-transitory machine-readable storage medium encoded with instructions for execution by a network processing device for creating a NAT session with a tunnel between two nodes, the non-transitory machine-readable storage medium comprising:
instructions for receiving, at the network processing device, a packet;
instructions for determining the packet does not have a Security Association;
instructions for establishing a Security Association associated with a tunnel;
instructions for generating a tunnel identifier for the tunnel, wherein the tunnel identifier is to be used in a NAT session request;
instructions for creating a NAT session information; and
instructions for storing the NAT session information and the tunnel identifier in a data store.

12. The non-transitory machine-readable storage medium of claim 11, wherein the instructions for creating a NAT session information further comprises:
instructions for performing a hash on a destination address, a source address, a protocol, and a port information stored in header fields of the packet.

13. The non-transitory machine-readable storage medium of claim 11, wherein the instructions for establishing a Security Association further comprises:
instructions for sending a request to a remote node, wherein the request comprises a cryptographic key, information identifying a first network endpoint and a first port and a second network endpoint and a second port, and a tunnel type.

14. The non-transitory machine-readable storage medium of claim 13, further comprising:
instructions for determining the second network endpoint based upon information stored in header fields of the packet.

15. The non-transitory machine-readable storage medium of claim 11, further comprising:
instructions for generating a NAT session request comprising the tunnel identifier.

16. A non-transitory machine-readable storage medium encoded with instructions for execution by a network processing device for processing a packet, the non-transitory machine-readable storage medium comprising:
instructions for receiving, at the network processing device, an encrypted packet comprising an encrypted first set of headers and an unencrypted second set of headers;
instructions for determining a NAT session information from the unencrypted first set of headers;
instructions for determining the NAT session information is associated with a tunnel;
instructions for decrypting the packet; and
instructions for sending the packet towards a destination address stored in the first set of headers.

17. The non-transitory machine-readable storage medium of claim 16, wherein the instructions for determining the NAT session information further comprises:
instructions for performing a hash on a destination address, a source address, a protocol, and a port information stored in the second set of headers; and
instructions for locating the NAT session information that matches the hash, wherein the NAT session information is stored in a table and comprises the hash.

18. The non-transitory machine-readable storage medium of claim 16, wherein the instructions for determining the NAT session information is associated with a tunnel further comprises:
instructions for determining the NAT session information comprises a tunnel identifier.

19. The non-transitory machine-readable storage medium of claim 16, wherein the instructions for sending the packet towards a destination address stored in the first set of headers further comprises:
instructions for performing a route lookup on the header information in the decrypted packet.

20. The non-transitory machine-readable storage medium of claim 16, further comprising:
instructions for determining the NAT session information is associated with an expired NAT session;
instructions for creating a new NAT session information; and
instructions for storing the new NAT session information and a tunnel identifier associated with the tunnel.
